(19) United States
(12) Patent Application Publication
(10) Pub. No.: US 2006/0242206 A1
(43) Pub. Date: Oct. 26, 2006

(54) System and method for peer to peer synchronization of files

(75) Inventors: John E. Brezak, Woodinville, WA (US); Mohammed A. Samji, Bellevue, WA (US); Nathan W. Johnson, Shoreline, WA (US); Ramkumar Ramasubramanian, Bellevue, WA (US); Robert B. Jervis, Bellevue, WA (US); Walter Vonkoch, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/111,895

(22) Filed: Apr. 22, 2005

(51) Int. Cl. G06F 17/30

(52) U.S. Cl. 707/201

(57) ABSTRACT

A system and related techniques provide a seamless, peer-to-peer file synchronization capability for sharing files, folders, directories or other stored content between machines. According to embodiments of the invention in one regard, a sync engine or other file management logic may be integrated into the operating system or other resources of a user's desktop, laptop, network-enabled cellular device or other computer, client, machine or other hardware. The sync engine may accept user designations of files, folders, directories or other contents which they wish to share, sync or roam between two or more selected machines, on an automatically consistent basis. The sync engine or other control logic may maintain a file system log to record the state of files which have been designated for sharing, to indicate for example whether a transmission of the file has been made, to which target machine or machines it has been transmitted, and other variables regarding the state of file or other content. According to embodiments of the invention in one regard, the sync engine may apply version management logic when files located on a target or destination machine, may, for example, reflect newer or more complete content than the file which is designated for roaming to that machine, or other under conditions. A user may therefore readily and with a comparative minimum of configuration effort select and effectuate the sharing of a set of frequently used or otherwise desired files to an arbitrary set of machines which they own or use, without a need to invoke a remote server or other control or storage to back up and synchronize that content.

### CROSS-REFERENCE TO RELATED APPLICATION

Not applicable.

### STATEMENT REGARDING FEDERALLY SPONSORED RESEARCH OR DEVELOPMENT

Not applicable.

### FIELD OF THE INVENTION

The invention relates to the field of computer file management, and more particularly to a platform for selecting and managing file sharing or synchronization between two or more computers, on a peer-to-peer basis without a need for an intervening server or other external resource.

### BACKGROUND OF THE INVENTION

Many personal computer users and users of other machines or clients today regularly own or use more than one machine. For example, many business, personal and other users own or use both a desktop machine and a laptop computer or other mobile client or device. Users who own or have access to multiple machines may use different machines at different times for different purposes, yet still frequently want to access commonly used files or other content on all those machines. However, most applications, databases and other resources lack the capability to automatically or natively “roam” or share those files to a common group of machines, so that the user may be able to work with the most up-to-date or complete version of a given file, no matter what machine they happen to be using.

Solutions have been marketed for purposes of addressing the file-syncing problem, including platforms which temporarily back up one machine to a remote Internet server or other resource. According to those techniques, however, the destination or target machine which is receiving the latest file, folder or directory image must wait to connect to the Internet to reach that remote server and initiate a file transfer of current files. Machines which do not operate with continuous Internet connections, such as many laptop or portable computers, may not therefore always allow the user to access that service. That may happen, for example, when a business or other user travels to a distant location without an immediate Internet access point. Moreover, file syncing solutions which depend on intermediate servers may crash, be suspended for maintenance or otherwise suffer from unpredictable interruptions in connectivity which may make the file-synchronization feature less reliable than desired. Other problems in file syncing and replication technology exist.

### SUMMARY OF THE INVENTION

The invention overcoming these and other problems in the art relates in one regard to a system and method for peer-to-peer synchronization of files, in which each of a user's designated machines may host or contain a sync engine or sync logic enabling those machines to independently discover, connect to and manage the user's desired set of shared files, on a peer-to-peer basis. According to embodiments of the invention in one regard, the automatic discovery and management of file roaming may be accomplished without the necessity for remote server storage or other remote resources, may rather be carried out using sync engine logic hosted or contained within an operating system or other local resource of each participating machine. According to embodiments of the invention in one regard, a user may register two, three or more machines for file synchronization services, and freely designate one or more files, folders, directories or other sources or content to be shared from any one or more of their set of machines to any one or more of the remainder of that registered set of machines. Each machine may transparently detect and discover connectivity status to other machines within the group, and automatically begin to roam or image selected files to or from that machine to other machines or destinations. The sync engine may in embodiments apply version management logic to detect version conflicts, and for example query the user for their preferred choices for backup and other options when version conflicts arise. According to embodiments of the invention in one regard, the user may therefore select or discover a set of working documents, images or other files, folders, directories or other sources or content to be automatically propagated throughout a set of working machines, with comparatively minimum configuration effort while achieving maximum currency for that set of files across all participating machines.

### BRIEF DESCRIPTION OF THE DRAWINGS

FIG. 1 illustrates an environment in which a system and method for automated peer-to-peer file synchronization may operate, according to embodiments of the invention.

FIG. 2 illustrates an interface depicting file version management logic which may be used in conjunction with file synchronization, according to embodiments of the invention.

FIG. 3 illustrates an environment in which a system and method for peer to peer synchronization of files may operate with more than two participating machines, according to embodiments of the invention in another regard.

FIG. 4 illustrates a flowchart of overall file roaming and synchronization processing, according to embodiments of the invention.

### DETAILED DESCRIPTION OF EMBODIMENTS

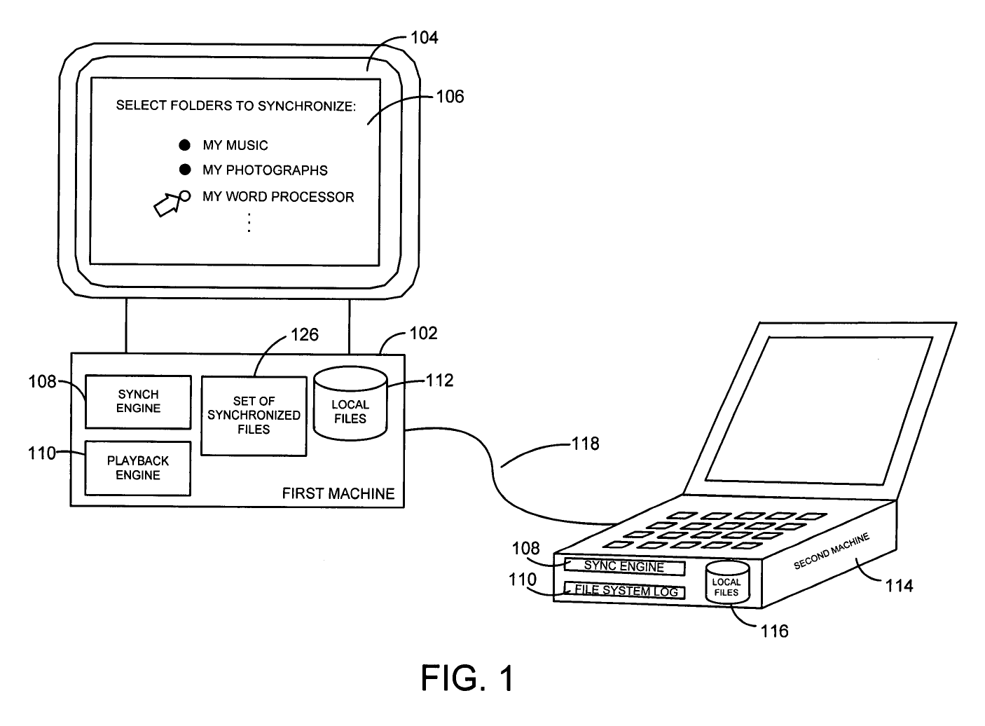

FIG. 1 illustrates an environment in which a system and method for peer-to-peer synchronization of files or other content may operate, according to an embodiment of the invention. As illustrated in that figure, a user may use or access a set of multiple computers, clients or other machines for business, personal or other uses, including a first machine 102, illustratively a desktop computer, and a second machine 114, illustratively a laptop or other mobile computer. Other computers, clients or other machines may be synchronized, including, for example, network-enabled cellular telephones, network-enabled email clients, network-enabled personal digital assistants, network-enabled media players, or other hardware. In operation as shown, the first machine 102 and second machine 114 may be connected via connection 118, such as a Universal Serial Bus connection, FireWire™ connection, BlueTooth™ connection, WiFi™ connection, or other wired, wireless, optical or other channel or connection. According to embodiments of the invention, connection 118 may be continuously maintained as in a local area network (LAN) or otherwise, or in embodiments be connected intermittently between two or more participating machines.

According to embodiments of the invention as illustrated, the first machine 102 may generate and present a user interface 104, such as a graphical user interface, command line interface, voice-activated or other interface to allow the user to access applications, files, operating system and other resources. According to embodiments as shown, the user may access a synchronization interface 106 to activate, select and manage file or other synchronization functions. In embodiments the synchronization interface 106 may be hosted within an operating system of first machine 102, or in further embodiments may be incorporated in one or more applications, modules or other resources. According to embodiments as shown, the synchronization interface 106 may present the user with selections and options for identifying, activating and managing synchronization events between first machine 102 and second machine 114, or other machines or targets. In general, those synchronization activities may involve the synchronization of selected or discovered files, folders, directories, volumes, disks or other content, information, storage or media between participating machines.

According to embodiments of the invention in one regard, the user may manipulate the synchronization interface 106 to select a set of synchronized files 126 for syncing or roaming across participating machines or systems. The set of synchronized files 126 may for instance contain files or other content identified from within a set of local files 112 stored on first machine 102, as well as from within another set of local files 116 stored on second machine 114, or other files or information. The set of synchronized files 126 may be identified, stored and managed by a sync engine 108 hosted in first machine 102. The sync engine 108 may communicate with a file system log 110 maintained in first machine 102, to track and record the state of files, folders, directories, volumes or other content or information designated for synchronization or roaming in the set of synchronized files 126, or otherwise. In embodiments, the second machine 114 or other or further participating machine may likewise maintain the same or similar logic in the form of another instance of sync engine 108, file system log 110 and other file management resources, each of which in embodiments may again be hosted in operating system or other resources.

According to embodiments of the invention, the set of synchronized files 126 may also for example be configured to include a user's most commonly used directories, folders or other sources, for example, illustrative folders such as My Documents, My Music, Desktop, Favorites or other folders or sources. According to embodiments in one regard, commonly used directories, folders or other sources may be configured to automatically advertise their availability for syncing to sync engine 108 or other resources, for easy selection or activation by the user, for instance by accepting or highlighting those sources and a sync destination. According to embodiments of the invention in a further regard, folders, directories or other sources may be selected or configured for syncing which are not specific to one user, for instance, folders or other content which are global to the syncing system, for example, task-oriented project folders, public folders such as folders of the form c:\users\public, or other folders, directories or other sources. In these and other embodiments of the invention, folders, directories and other sources may be automatically discovered by discovery logic on any one or more machine, in addition to or instead of manual specification of that content. Likewise, in embodiments of the invention, in addition to or instead of manually registering an address or identifier for destinations machines, machines which may be candidates for inclusion in the set of participating machines may also be automatically detected using discovery logic, such as logic which may detect machines connected on a local area network, or otherwise.

For purposes of sync management, the sync engine 108 in first machine 102, second machine 114 or otherwise may detect the connection status of first machine 102, second machine 114 or other machines or hardware to determine those occasions when those machines enjoy connectivity between each other or other participating hardware, via connection 118 or other connections or channels. For example, the sync engine 108 may establish a connection through available communication ports of first machine 102, second machine 114 or other participating machines, including for example tunneling through firewall resources as appropriate.

When connectivity is established, for instance via USB or wireless connections, the sync engine 108 in first machine 102 or otherwise may in embodiments authenticate the participating machines to ensure that file synchronization is being properly initiated. When an authenticated connection is verified, the sync engine 108 in first machine 102 or otherwise may initiate automatic file roaming, imaging or synchronization activity between the participating machines. For instance, the sync engine 108 in fist machine 102 or otherwise may access the set of synchronized files 126 to determine which files, folders, directories, volumes or other content located on first machine 102 need to be transferred to second machine 114, and likewise which similar content located on second machine 114 need to be transferred to first machine 102 to maintain a coherent or consistent set of files or other information between those machines.

The sync engine 108 in first machine 102 or otherwise may thus, for instance, examine the file system log 110 of first machine, file system log 110 of second machine 114 or otherwise to examine the state, behavior or history of the files and other content on the participating machine. The state, behavior, history or other metadata or information regarding the set of synchronized files 126 may, for instance, include not merely date-stamp information indicating the most recent editing, downloading or accessing of a file, but further information such as file size, file type, information regarding previous versions or transmissions of a file, and other information.

Accessing this and other information regarding the state of the file and other content on participating machines, the sync engine 108 of first machine or otherwise may for instance delete, copy, edit, reformat, change the stored location of, or otherwise manipulate the set of synchronized files 126 in one or more locations. These actions may be performed, for instance, to ensure that the same version of a given file is maintained in first machine 102, second machine 114 and other participating machines. According to embodiments of the invention in one regard, the sync engine in first machine 102 or otherwise may apply delta syncing logic to the processed files, to cause only those files or portions of files which have changed since the last synchronization or other point to be roamed between participating machines. In embodiments of the invention involving corporate or other organizational LANs, for example, a systems administrator or others may set the sync engine 108 of first machine 102 or other machines to restrict the propagation of certain files to certain users, or apply other synchronization controls. When permissions are applied, it may be noted that permissions must be arranged so that the data can properly migrate through to all participating machines, for instance to ensure connection paths to all necessary destinations. Other configurations are possible.

According to embodiments of the invention in a further regard, the user, administrator or operating system settings may for example set the sync management, file transfer and other activities carried out by the sync engine 108 of first machine 102, the sync engine 108 of second machine 114 or other resources to execute at a desired level of priority, for instance to operate as a background task, or to suspend and resume file transfer activities until broadband connectivity is established or reestablished, or take other actions at other times or under other conditions. According to embodiments of the invention in one regard, first machine 102, second machine 114 or other participating machines, clients, devices or hardware may, for instance, be identified by a domain name service (DNS) or other address or identifier. In embodiments of the invention in this regard, the sync engine 108 of first machine 102, sync engine 108 of second machine 114 or other sync engine instances or logic may employ automatic discovery logic to detect when other participating machines appear on the Internet or other networks, so that, for example, the machines may resume syncing activity with other machines at any point during which they enjoy Internet or other connectivity.

It may be noted that according to embodiments of the invention, in general, the user may selectively or arbitrarily choose those files or other source content they wish to replicate, roam or synchronize amongst their set of participating machines, from any one or more of those machines, without restriction. Moreover, the first machine 102, second machine 114 and any other participating machines may share a set of synchronized files 126 on a group basis, but those machines do not need to be directly connected together or connected together at the same time to carry out the synchronization operations of the invention. Rather, synchronization activity may take place automatically and opportunistically depending on connection, network and other conditions for each machine or subgroup or sub-network of machines. (It may be noted that in such embodiments, the set of participating machines must nevertheless be able to achieve a fully bridged or connected network on an overall or cumulative basis, even if machines, subgroups or sub-networks of machines connect at different times, different places or using different types of network connections). According to embodiments of the invention in another regard, a user may choose to designate all files located on first machine 102, second machine 114 or otherwise to be roamed or synced to another participating machine, to effect a backup of those source files, if desired.

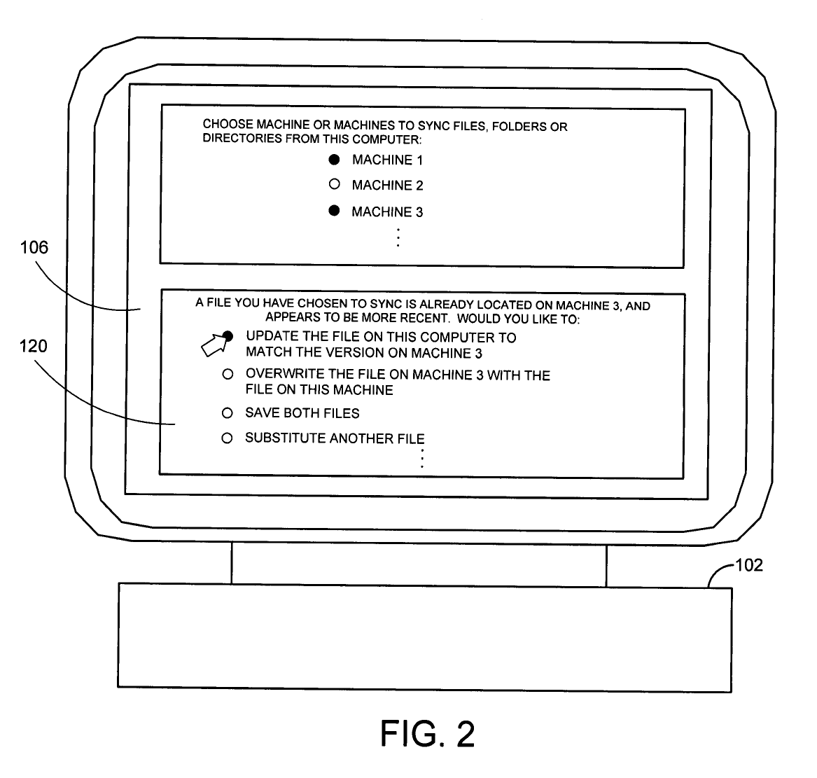

According to embodiments of the invention illustrated in FIG. 2, the sync logic 108 of first machine 102, the sync logic of second machine 114 or other logic or instances may apply version management logic 120 in conjunction with the carrying out of file transfers and updates. In embodiments as shown, when that sync logic 108 detects a version conflict between two instances of a file, for instance that an older file is being prepared to overwrite a newer version of that same file, the version management logic 120 may for instance present the user with a dialogue or query to resolve that conflict, for instance to rename or move the obsolete file, to substitute another version of the file, or take other action. Other version-based and other conflicts may be detected. In embodiments, rather than or in addition to presenting the user with a rich interface for exception handling, the version management logic 120 may also apply automatic rules or processing to conflicting files or data, such as executing a compare function to edit or conform those file, or otherwise processing the differing versions.

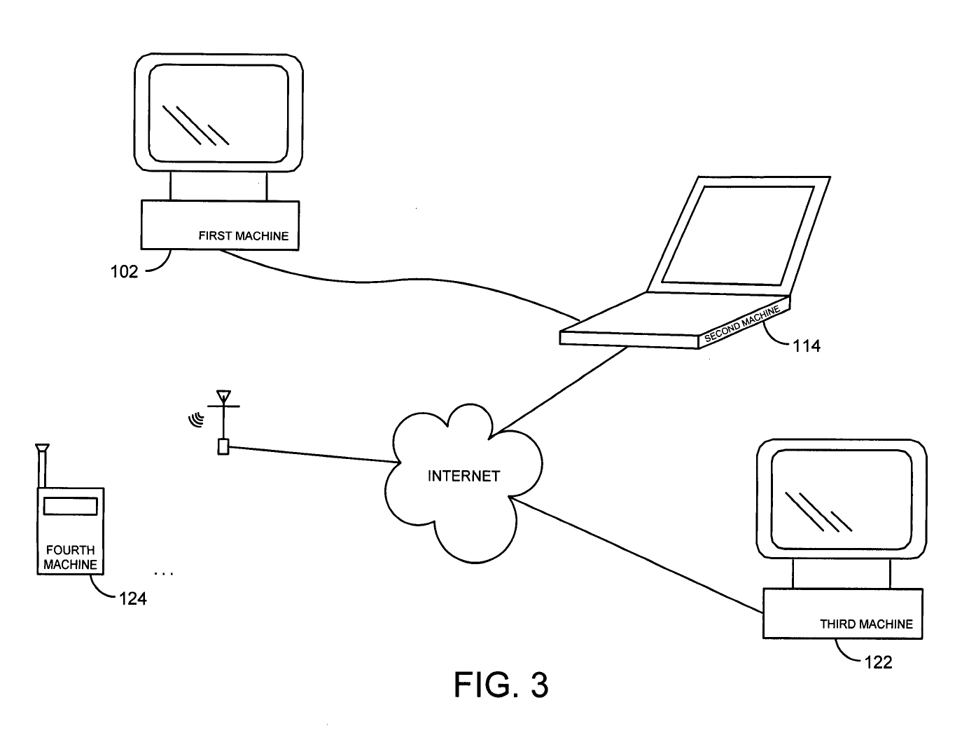

It may again be noted that in embodiments of the invention, and as for example as illustrated in FIG. 3, more than two machines may participate in file synchronization and related functions, on the same automatic basis. A collection of machines as shown may include at least a first machine 102, second machine 114, third machine 122, fourth machine 124 or further machines, clients, computers or devices to synchronize selected file or other content. In embodiments those machines may be connected directly via a wired connection such as connection 118 illustrated in FIG. 1, or by other wired, wireless or optical connection, including air interfaces for network-enabled cellular telephones, and others. In embodiments of the invention in one regard, however, the user may initiate selective synchronization of desired files with comparatively little configuration effort, and without the need for or reliance on an intermediate storage, logic or control resource such as an Internet backup server. Embodiments of the invention may therefore enhance the reliability, speed and inter-operability of file roaming operations.

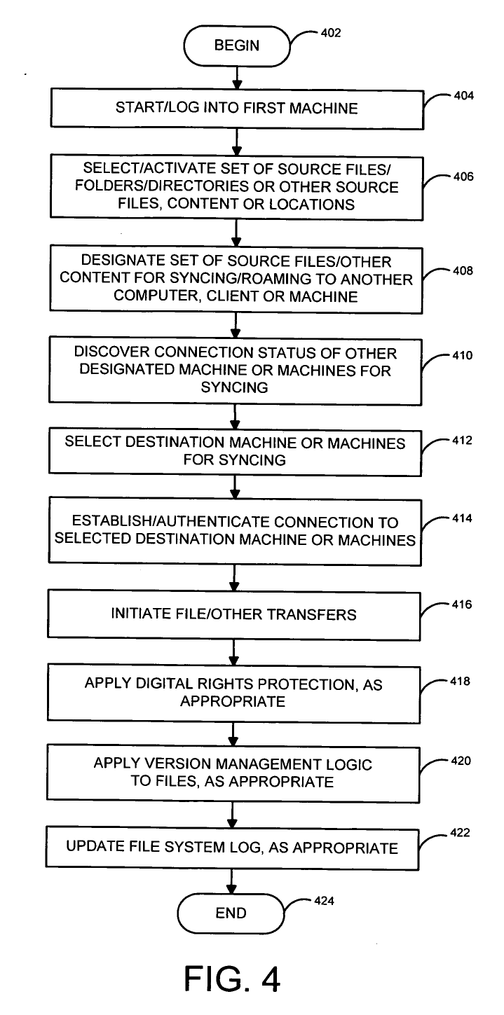

FIG. 4 illustrates overall file sharing and synchronization processing, according to embodiments of the invention. In step 402, processing may begin. In step 404, a user may start or log into a first machine 102, such as a personal computer, laptop or mobile computer, a network-enabled cellular telephone, or other client, machine, hardware or device. In step 406, the user may select or activate a set of source files, folders, directories or other source files, source locations, or other information or content, for instance highlighting a set of files on the first machine 102 or other location. In step 408, the user may designate a set of synchronized files 126 to be automatically synchronized and managed amongst a set of working computers or other machines. In step 410, the network connection status of those designated machine or machines may be automatically discovered, for instance by sync engine 108 or other logic. In step 412, the user may select, or the sync engine 108 may retrieve a stored designation of, one or more destination machines for file or other data syncing.

In step 414, a connection 118 such as a USB or other wired or wireless connection may be established and authenticated to connect to the selected machine or machines, such as a second machine 114 or other computer, machine, client or hardware. In step 416, the sync engine 108 or other control logic may initiate file transfers of the set of synchronized files 126 or other content transmission between the first machine 102 and the second machine 114. In step 418, the sync engine 108 of either the first machine 102 or second machine 114 or both may apply digital rights management or protection logic to the set of synchronized files 126 or other content being transferred. According to embodiments of the invention in this regard, the sync engine 108 of any one or more participating machine may in cases automatically seek authorization or licenses to replicate the file or content, such as music or other media content. In the event that authorization is denied, the operative sync engine 108 may, for example, delete the unauthorized file or files from the target machine, notify the user that an unauthorized copy has been removed, or take other action.

In step 420, the sync engine 108 of either the first machine 102 or second machine 114 or both may apply version management logic 120 to the set of synchronized files 126 or other content being transferred, for example to trap instances of inconsistent versions of files, of obsolete versions of files being attempted to be copied over newer versions, or detect other version conflicts. According to embodiments of the invention in one regard, the version management logic 120 may present the user with a dialogue to obtain their preferred disposition of version conflicts, such as for example to roam the most current version of a file, to rename or back up obsolete versions of files, to substitute other files for versions in conflict, or take other action. In step 422, the sync engine 108 or other logic in one or more of the participating machines may update the file system log 110 in that corresponding local machine or hardware. In step 424, processing may repeat, return to a prior processing point, jump to a further processing point or end.

The foregoing description of the invention is illustrative, and modifications in configuration and implementation will occur to persons skilled in the art. For instance, while the invention has generally been described in terms of personal computers roaming files to other desktop or mobile personal computers, in embodiments again the file syncing capabilities of the invention may be applied to other types of devices, such as network-enabled cellular telephones, network-enabled email clients, network-enabled personal digital assistants, network-enabled media players, or other clients, machines or hardware.

Similarly, while the invention has in embodiments been generally described as migrating files themselves between participating machines, in embodiments other types of content, information or data may be synced, such as hardware configuration settings, desktop images from a user's customized interface, operating system resources or tools, or other media, content or information. Other hardware, software or other resources described as singular may in embodiments be distributed, and similarly in embodiments resources described as distributed may be combined. The scope of the invention is accordingly intended to be limited only by the following claims.

We claim:

1. A system for managing the synchronization of data, comprising:
an input interface to receive a designation of a set of content for synchronization; and
a sync engine, the sync engine communicating with the input interface to receive the designation of the set of content and synchronize the set of content without intermediate control on a set of participating machines.

2. A system according to claim 1, wherein the set of content comprises at least one of files, folders, directories, volumes, disk media and electronic media.

3. A system according to claim 2, wherein the set of content is automatically advertised for sync selection by the user.

4. A system according to claim 1, wherein the synchronization comprises transmitting consistent versions of the set of content to the set of participating machines.

5. A system according to claim 1, wherein the sync engine comprises an engine hosted in at least one of an operating system and an application.

6. A system according to claim 1, wherein at least one of the set of content and the set of participating machines are automatically detected by discovery logic.

7. A system according to claim 1, wherein the set of content is synchronized via at least one of a direct connection between participating machines and a network connection between participating machines.

8. A method for managing the synchronization of data, comprising:
receiving a designation of a set of content for synchronization; and
receiving the designation of the set of content in a sync engine to synchronize the set of content without intermediate control on a set of participating machines.

9. A method according to claim 8, wherein the set of content comprises at least one of files, folders, directories, volumes, disk media and electronic media.

10. A method according to claim 9, wherein the set of content is automatically advertised for sync selection by the user.

11. A method according to claim 8, wherein the synchronization comprises transmitting consistent versions of the set of content to the set of participating machines.

12. A method according to claim 8, wherein the sync engine comprises an engine hosted in at least one of an operating system and an application.

13. A method according to claim 8, further comprising automatically discovering at least one of the set of content and the set of participating machines.

14. A method according to claim 8, wherein the set of content is synchronized via at least one of a direct connection between participating machines and a network connection between participating machines.

15. A set of synchronized content, the set of set of synchronized content being generated according to a method comprising:
receiving a designation of a set of content for synchronization; and
receiving the designation of the set of content in a sync engine to synchronize the set of content without intermediate control on a set of participating machines.

16. A set of synchronized content according to claim 15, wherein the set of content comprises at least one of files, folders, directories, volumes, disk media and electronic media.

17. A set of synchronized content according to claim 16, wherein the set of content is automatically advertised for sync selection by the user

18. A set of synchronized content according to claim 15, wherein the synchronization comprises transmitting consistent versions of the set of content to the set of participating machines.

19. A set of synchronized content according to claim 15, wherein the sync engine comprises an engine hosted in at least one of an operating system and an application.

20. A set of synchronized content according to claim 15, wherein the method further comprises comprising automatically discovering at least one of the set of content and the set of participating machines.
